(19) United States
(12) Patent Application Publication
(10) Pub. No.: US 2011/0051186 A1
(43) Pub. Date: Mar. 3, 2011

(54) IMAGE SCANNING DEVICE AND COMPUTER READABLE RECORDING MEDIUM STORING CONTROL PROGRAM OF IMAGE SCANNING DEVICE

(76) Inventors: Takeo KATSUDA, Tokyo (JP); Ryo Yagi, Tokyo (JP)

(21) Appl. No.: 12/860,316

(22) Filed: Aug. 20, 2010

(30) Foreign Application Priority Data
Aug. 25, 2009 (JP) 2009-194275

(51) Int. Cl. G06F 3/12; H04N 1/00

(52) U.S. Cl. 358/1.15; 358/403

(57) ABSTRACT

The MFP capable of scanning images acquires from the file server which the server management table associates with the authorized user the file information for the scan data stored in the associated file server, lays out the acquired scanned data on the Web page 800, and receives the acquisition request for the scanned data corresponding to the user-selected file information among all the file information laid out on the Web page. The MFP then acquires the scanned data corresponding to the user-selected file information from the file server, and distributes the acquired scanned data to the user.

### CROSS-REFERENCE TO RELATED APPLICATION

This application is based on Japanese Patent Application No. 2009-194275, filed on Aug. 25, 2010, the contents of which are incorporated herein by reference.

### BACKGROUND

1. Technical Field

The present invention relates to an image scanning device, and a computer readable recording medium storing a control program of the image scanning device. The present invention relates, in particular, to an image scanning device capable of scanning a document image to generate scanned data and transmitting the scanned data to have a file server store it, and a computer readable recording medium storing a control program of the image scanning device.

2. Description of Related Art

There exists an MFP (Multi-Function Peripheral) which is capable of transmitting scanned data of the original document to have a file server store it. If an user wishes to use the scanned data thus stored, he/she has to know in advance the IP address, the file name of the scan data, etc. For such needs, there is well-known technology of e-mailing user notification that the scanned data has been stored in a specific folder (See Japanese Unexamined Publication No. 2005-173891).

However, such e-mail notification function entails prior registration of e-mail addresses to a device such as a MFP. Moreover, management of the received e-mails put a heavy burden on the user as he/she may receive a large amount of e-mails on a daily basis. Suppose that the user wishes to use scanned data which has been generated by MFP half a year ago, the notification e-mail for the scanned data must be stored in the MFP and, even so, the user will still go through a chore of searching the storage for the particular email.

Furthermore, security policies to be applied to scanned data after transmission depends on settings on a file server of the transmission destination, in general terms. Consequently, user can hardly establish access control to the scanned data after transmission as it requires high knowledge of various settings on the transmission destination file server including user settings and access control settings.

The present invention is intended to solve the above-mentioned problems, and to provide an image scanning device and a computer readable recording medium storing a control program of the image scanning device that can assist user with controlling access to scanned data generated by the image scanning device.

### SUMMARY

In order to accomplish at least one to the objectives described above, an image scanning device capable of communicating with file storage devices, which reflects one aspect of the present invention comprise: an image scanning unit for scanning a document image to generate scan data; a scanned data transmission unit for transmitting the generated scanned data to have a file storage device to store it; a Web server function unit for offering a Web page; a memory unit for storing a server management table for managing association between users and file storage devices; an authorization unit for authorizing an user accessing said Web server function unit; a file information acquisition unit for acquiring from information for the file storage device which said server management table associates with the user having been authorized by said authorization unit, the file information for the scanned data stored in the associated file storage device; a layout unit for laying out the acquired file information on said Web page; a reception unit for receiving an acquisition request for the scanned data corresponding to the user-selected file information among all the file information laid out on said Web page; a scanned data acquisition unit for acquiring the scanned data corresponding to the user-selected file information, from the file storage device which has been the transmission source of the user-selected file information; and a scanned data distribution unit for distributing the acquired scanned data to the user.

Preferably, said layout unit lays out the server information for the file storage device which said server management table associates with the authorized user on said Web page, so that said file information on said Web page is accompanied by the server information for the file storage device which has been the transmission source of said file information on said Web page.

Preferably, each of said file storage device has a plurality of directories, said server management table manages association between users and at least one of said directories, and said Web page lays out the file information for the scanned data in the directories which said server management table associates with the authorized user among al all the scanned data stored in said file storage device.

Preferably, said file information includes thumbnail image data representing the scanned data.

Preferably, said file information takes a form of either a list of information on the scanned data including filenames, or thumbnail images representing the scanned data, and said list and said thumbnail images can be switched to each other according to user's instruction.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall structure of a network system according to an embodiment of the present invention.

FIG. 2 is an example of block diagram showing the structure of the MFP.

FIG. 3 is a sequence chart showing the outlines of the scanned data transmission process.

FIG. 4 is a sequence chart showing the outlines of the scanned data acquisition process.

FIG. 5 is a continuation of the sequence chart in FIG. 4 showing the outlines of the scanned data transmission process.

FIG. 6 is a diagram illustrating a setting screen for the user authorization settings on the scanned data.

FIG. 7 is a diagram illustrating a registration screen for the registration of the access right to the scanned data transmission destination.

FIG. 8 is a diagram for illustrating the server management table stored in the MFP.

FIG. 9 is a diagram illustrating the scanned data management page offered by the Web server function unit installed on the MFP.

FIG. 10 is a diagram illustrating the scanned data management page offered by the Web server function unit installed on the MFP.

FIG. 11 is a flowchart showing the steps of the scanned data transmission process executed by the MFP.

FIG. 12 is a flowchart showing the steps of the scanned data acquisition process executed by the PC.

FIG. 13 is a flowchart showing the steps of the scanned data transmission process executed by the MFP.

FIG. 14 is a continuation of the flowchart in FIG. 13 showing the steps of the scanned data transmission process executed by the MFP.

FIG. 15 is a flowchart showing the steps executed by the file server.

FIG. 16 is a diagram illustrating the scanned data management page displayed when “User B” logs in.

FIG. 17 is a diagram illustrating the download execution screen.

### DETAILED DESCRIPTION

The embodiments of this invention will be described below with reference to the accompanying drawings.

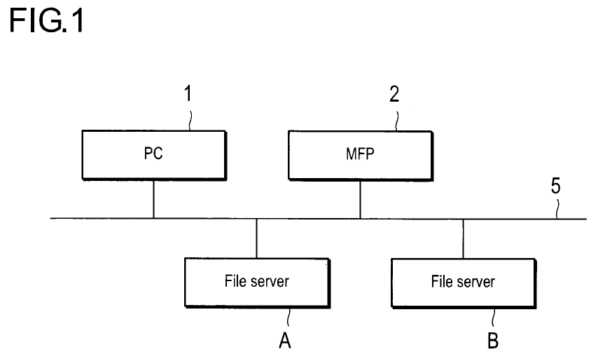

FIG. 1 is a block diagram showing the overall structure of the network system according to an embodiment of the present invention.

As shown in FIG. 1, the network system according to the present embodiment includes the PC (personal computer) 1 serving as a client terminal, the MFP 2 serving as an image scanning device for scanning images of documents, photographs, etc to and to generate scanned data and transmitting the scanned data, and the file servers A, B each serving as a file storage device for storing the scanned data transmitted from the MFP 2, and all these devices are connected one another via a network 5. The number and types of devices to be connected to the communication network 5 are not limited to those shown in FIG. 1. The MFP 2 and file servers A, B communicate one another using communication protocols like FTP (File Transfer Protocol) and SMB (Server Message Block).

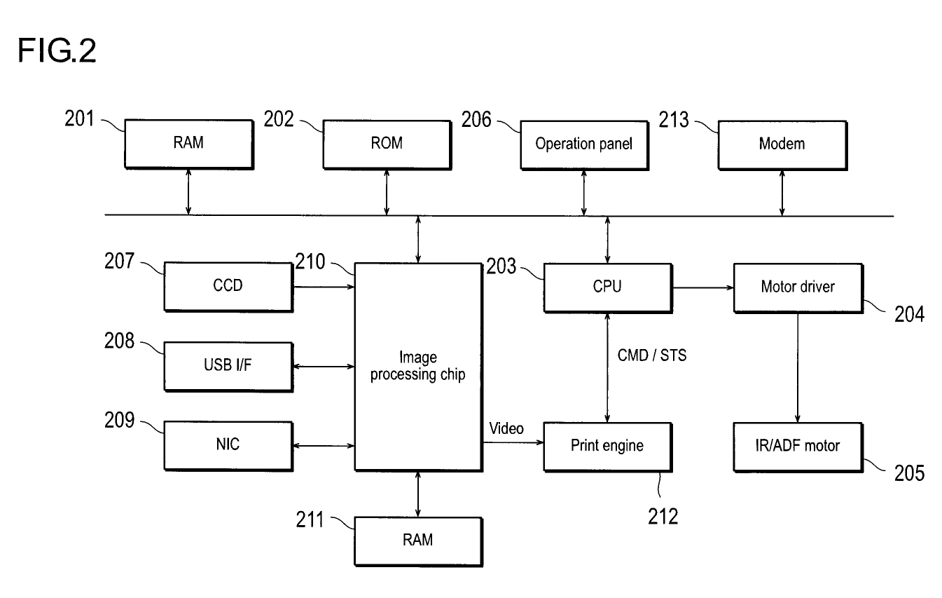

FIG. 2 is a block diagram showing the structure of the MFP 2.

The MFP 2 includes a CPU 203, a ROM 202, a RAM 201, a motor driver 204, an IR/ADF motor 205, an operation panel 206, a CCD image sensor (hereinafter also called “CCD”) 207, a USB interface 208, an NIC (Network Interface Card) 209, an image processing chip 210, a RAM 211 for image processing, a print engine 212, and a modem 213. The NIC 209 is connected to the network 5, and the modem 213 is connected to the public telephone network.

The CPU 203 reads the control programs stored in the ROM 202 into the RAM 201 to perform the overall control of various functions such as printing, copying, scanning and faxing in accordance with the control programs operating on the RAM 201. The RAM 201 is not only used as a working area of the control programs, but also as a temporally storage for storing image data, various calculation results, and so forth.

The ROM 202 also stores control programs of the Web server function unit and the database for the Web page offered by the Web server function unit. The PC 1 is capable of accessing the Web page offered by the MFP 2 via a Web browser installed on the PC 1.

Upon receiving an instruction of copying, scanning, or faxing on the operation panel 206, the CPU 203 carries out control of the motor driver 204 of the IR/ADF motor, and requests the image processing chip 210 to perform image processing. Upon receiving the image processing request from the CPU 203, the image processing chip 210 acquires image data from the CCD 207, executes image processing for the purpose of converting the image data into a format specified by user on the operation panel 206, and stores the converted image data in the RAM 201 as scanned data. Various calculation results are also stored in the RAM 211 for image processing. User can specify arbitrary file formats for the scanned data such as TIFF and PDF.

If an instruction of scanning is accepted by the operation panel 206, the scanned data is temporarily stored in the RAM 201 to be transferred to the USB interface 206 or the NIC 209. If an instruction of faxing is accepted by the operation panel, the scanned data is temporarily stored in the RAM 201 to be transferred to the modem 213. If an instruction of copying is accepted by the operation panel 206, the scanned data is temporarily stored in the RAM 201 to be transferred to the print engine 212.

Detailed descriptions of the PC1 and the file servers A, B are omitted as the PC 1 and the file server A, B are a general-purpose PC and general-purpose file servers like FTP and SMB servers, respectively.

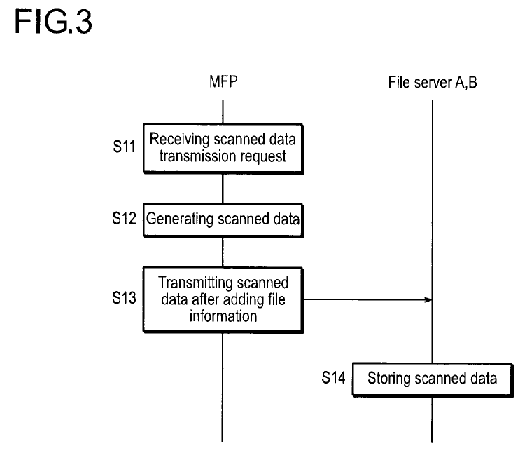

Next, the outlines of the operation by the network system of the present embodiment are given as follows with reference to the FIG. 3 to FIG. 6:

FIG. 3 is a sequence chart showing the outlines of the scanned data transmission process.

First, upon receiving the scanned data transmission request from the operation panel 206 (S11), the MFP 2 scans the original document to generate scanned data (S12).

Next, the MFP transmits the scanned data to the file server after adding to the scanned data file information such as thumbnail image data (S13).

The file server receives the scanned data with the file information from the MFP 2, and stores it in its memory unit (S14).

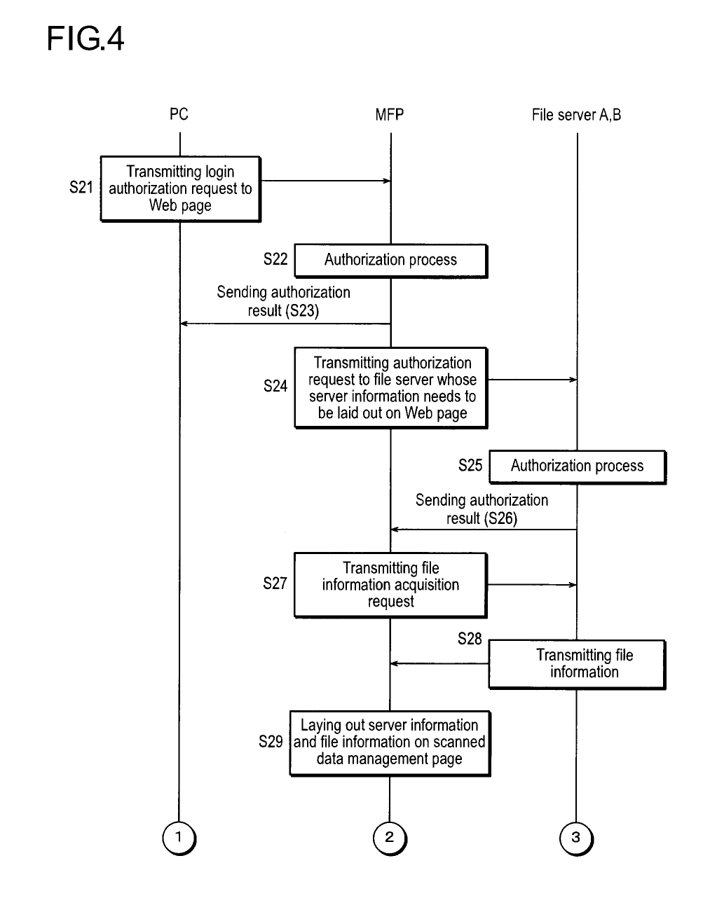

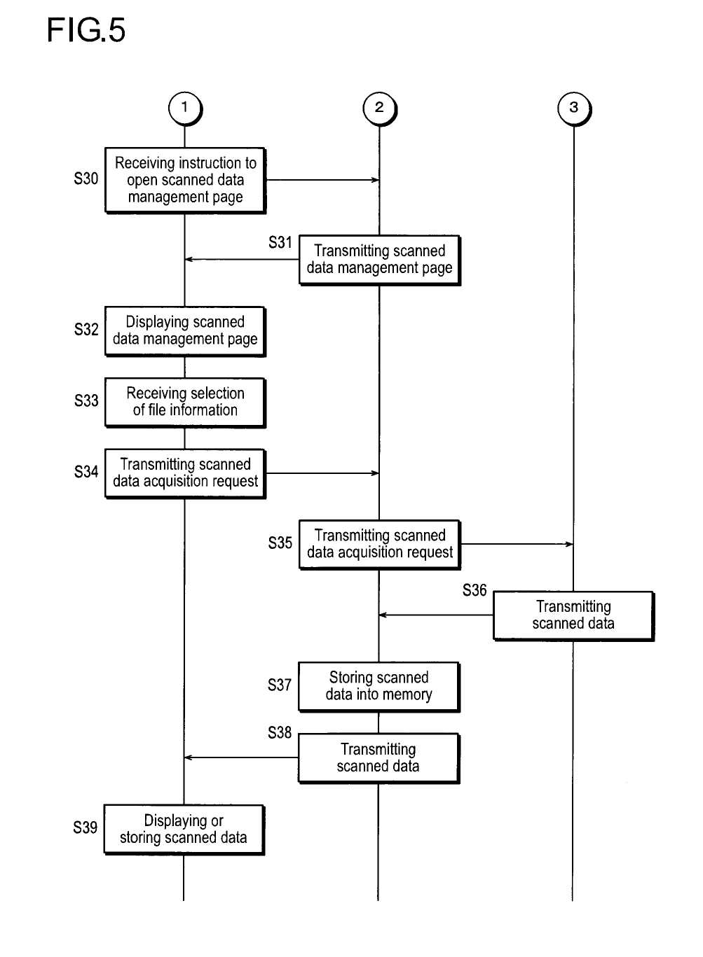

Each of FIG. 4 and FIG. 5 is a sequence chart showing the outlines of the scanned data acquisition process.

Firstly, the PC 1 transmits to the MFP 2 a login authorization request to a Web page (S21).

Upon receiving the login authorization request from the PC 1, the MFP 2 executes the authorization process with reference to the account name and password contained in the login authorization request (S22), and transmits the authorization result to the PC 1 (S23).

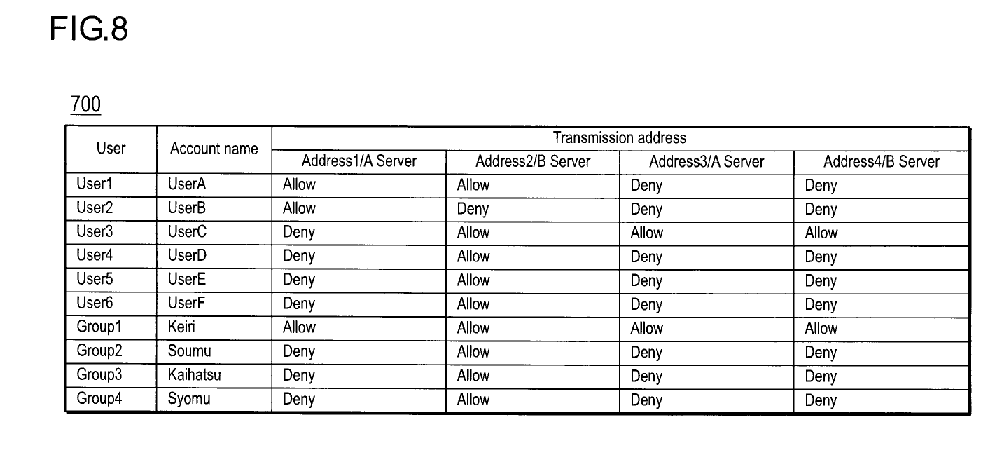

If the authorization result turns out “OK”, the MFP 2 then transmits the authorization request to the file server whose server information needs to be laid out on the Web page, referring to the server control table (FIG. 8) as described later (S24).

Upon receiving the authorization request from the MFP 2, the file server executes the authorization process using the authorization information contained in the authorization request (S25), and transmits the authorization result to the MFP 2 (S26).

Upon receiving authorization “OK” from the file server, the MFP 2 transmits to the file server which has been the transmission source of the authorization result, an acquisition request for the file information stored in the same file server (S27).

Upon receiving the file information acquisition request from the MFP 2, the file server extracts the file information stored in its own file server to transmit the requested file information to the MFP 2 (S28).

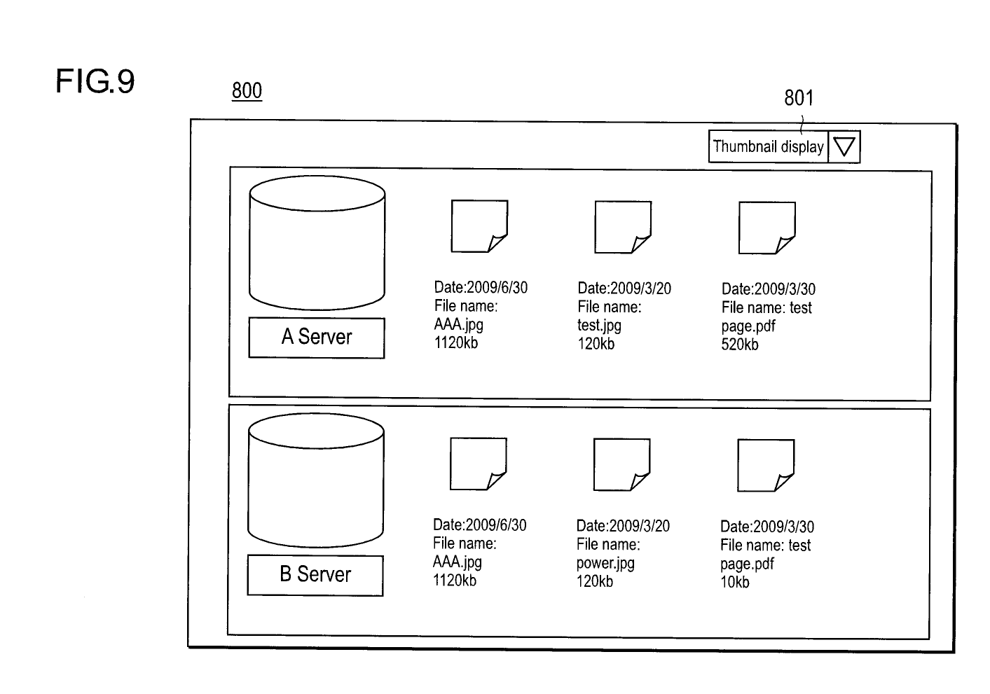

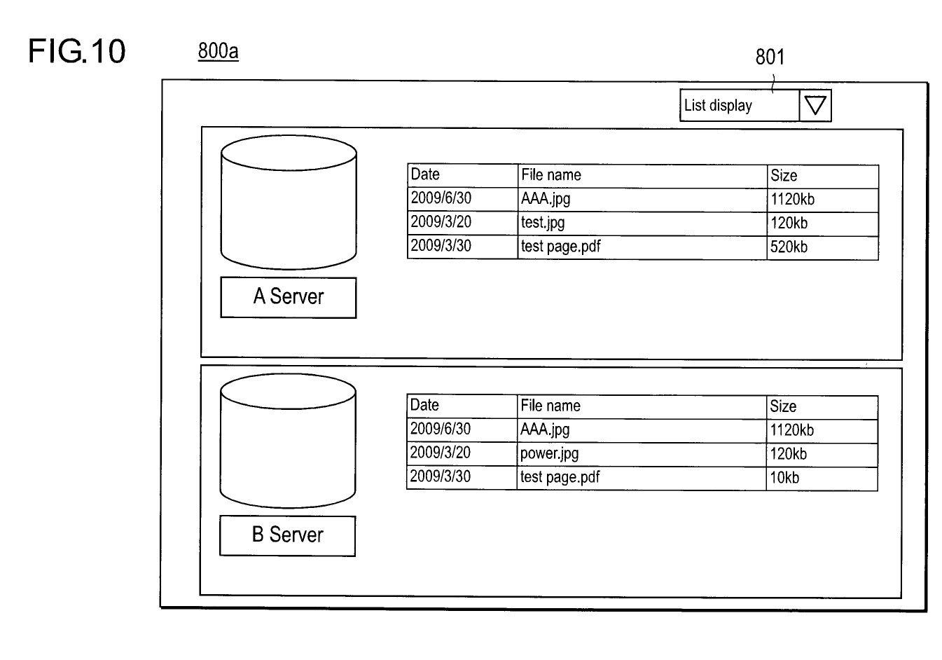

Upon receiving the file information from the file server, the MFP 2 lays out not only the server information for the file server which has been the source of the file information, but also the received file information, on the scanned data management page (refer to FIG. 9, FIG. 10) which forms a part of the Web page (S29).

When the PC 1 receives user's instruction to open the scanned data management page (S30), the MFP 2 transmits to the PC 1 the scanned data management page with the server information and the file information being laid out, in response to the request from the PC 1 (S31).

The PC 1 then displays the scanned data management page on its display (S32).

Next, The PC 1 receives user's selection of specific scanned data from the list of the file information laid out on the scanned data management page (S33), in order to transmit to the MFP 2 an acquisition request for the user-selected scanned data (S34).

The MFP 2 then transmits to the file server the acquisition request for the specific scanned data, in response to the acquisition request for the scanned data from the PC 1 (S35).

Upon receiving the acquisition request from the MFP 2, the file server extracts the scanned data from its own file server to transmit it to the MFP 2 (S36).

The MFP 2 stores the scanned data received from the file server to its memory (S37) before transmitting it to the PC 1 (S38).

The PC 1 either displays the scanned data received from the MFP 2 on its display, or stores it into the memory unit (S39).

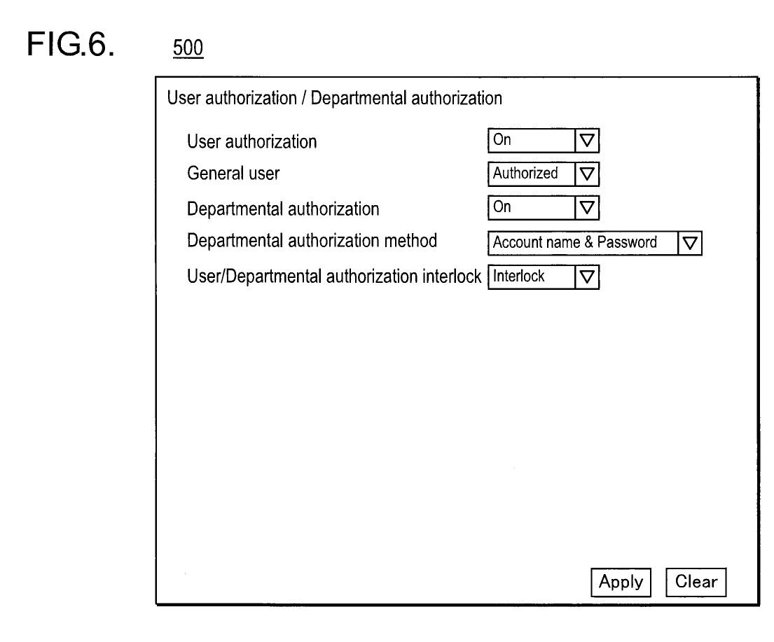

FIG. 6 is a diagram illustrating a setting screen for user authorization settings on the scanned data.

The setting screen 500 shown in FIG. 6 is offered by MFP 2's Web server function unit via the Web browser installed on the PC 1. User can configure the user authorization settings so that he/she can view the scanned data on this setting screen 500. More specifically, the user can determine whether or not a member of each department, each user, or a general user is allowed to view the scanned data stored in the file server. The term “user” herein means not only an individual user in a literal sense, but also an member of each department and a general user.

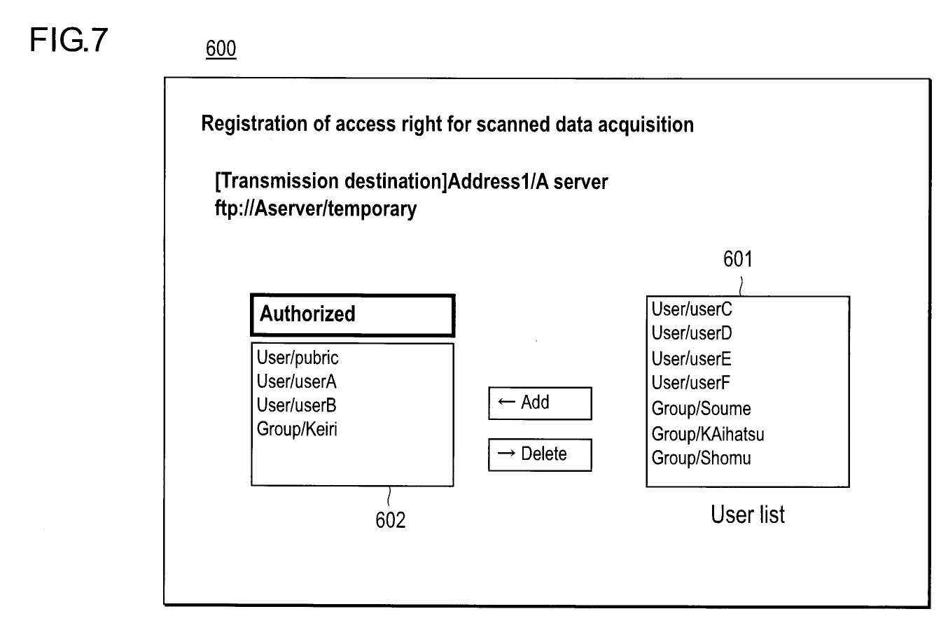

FIG. 7 is a diagram illustrating a registration screen for registration of the access right to the scanned data destination.

The registration screen 600 shown in FIG. 7 is offered by MFP 2's Web server function unit via the Web browser installed on the PC 1. On this screen 600, user can select a specific user among those displayed in the user list display region 601 within the registration screen 600 in order to authorize an access right to the data transmission destination (e.g. the file server A shown in FIG. 7) to the selected user. The selected user given the access right is displayed in an authorized user display region 602.

FIG. 8 is a diagram illustrating the server management table stored in the MFP 2.

The server management table 700 is generated to be stored in an nonvolatile memory such as EEPROM for the purpose of managing association between users and file servers based on the contents configured and registered on the setting screen 500 and the registration screen 600, respectively. The server management table 700 can also be stored in MFP 2's hard disk, if any. The server management table 700 shows association between each authorized user and the file server which the user is authorized to access.

FIG. 9 and FIG. 10 each shows a diagram illustrating the scanned data management page offered by MFP 2's Web server function unit.

The MFP 2 acquires the file information including transmission date/time, file name, data size, and thumbnail image data from the file server, in order to lay out these contents on the scanned data management page, which forms a part of the Web page installed on the MFP 2 in a graphical manner. The scanned data management pages 800, 800a are displayed by the PC 1 via its Web browser.

User can select either the list display for displaying the list including file names of the scanned data, or the thumbnail display for displaying the information including the thumbnail image data for the scanned data, and these display forms can be switched to each other by means of the display switching unit 801 within the scanned data management pages 800, 800a. The list display can achieve simultaneous display of a large amount of file information at once, while the thumbnail display can allow user to quickly check the contents of the scanned data, and therefore the capability to switch these display forms enhances user's convenience.

The operation of the network system in this embodiment will be described as follows:

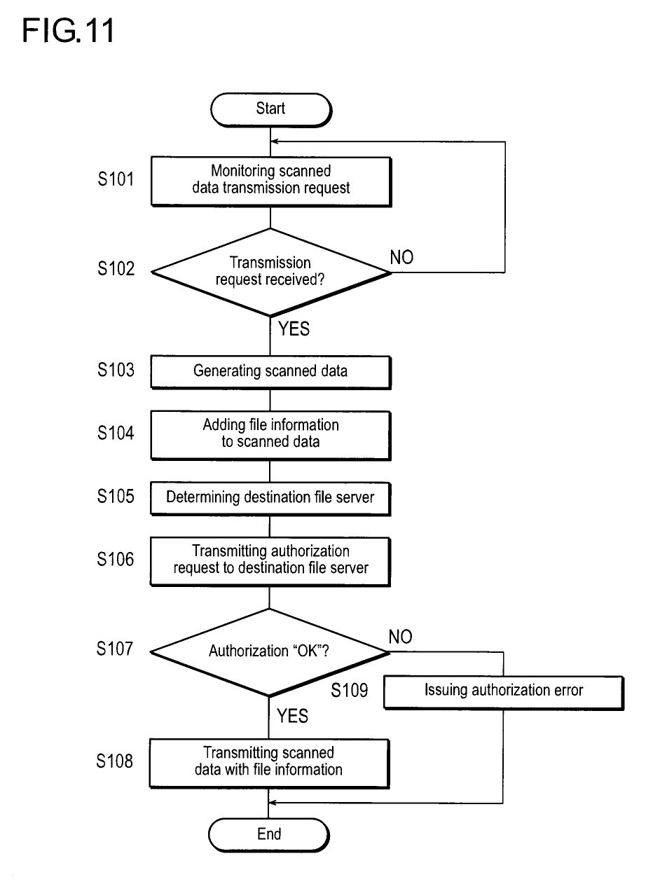

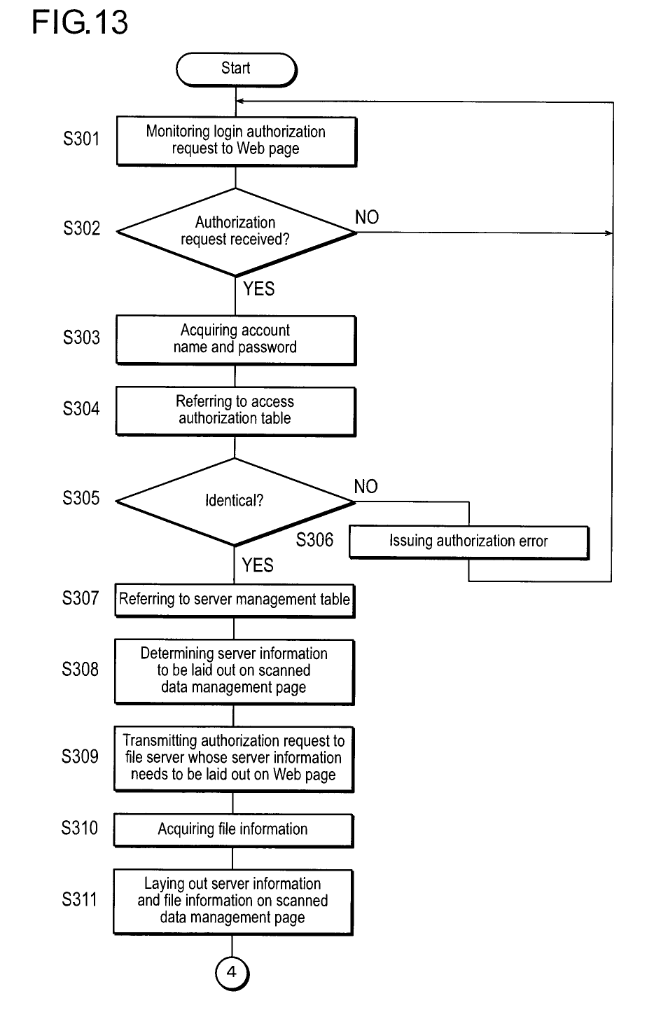

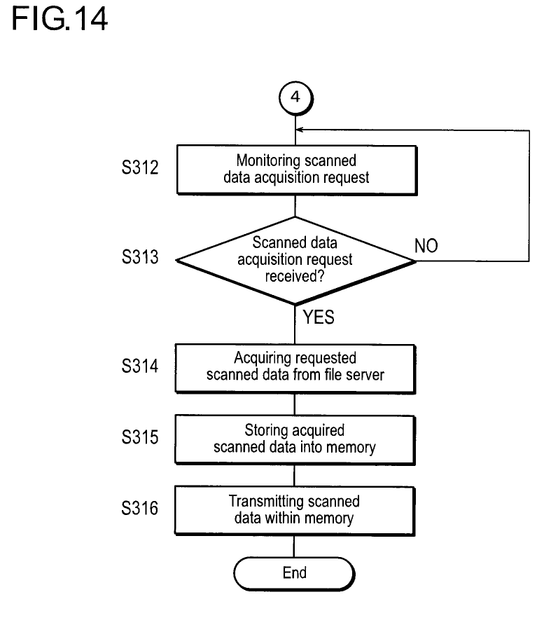

FIG. 11 is a flowchart showing the steps of the scanned data transmission process executed by the MFP 2. The algorithm shown in the flowchart of FIG. 11 is stored as a program in a memory unit such as ROM 202, and is read into RAM 201 to be executed by the CPU 203 (Same in the flowcharts of FIG. 13 and FIG. 14).

The MFP 2 monitors user's scanned data transmission request via the operation panel 206 (S101) to stand by until it receives a scanned data transmission request (S102: No).

The user can make the scanned data transmission request on the operation panel 206 for data transmission to a destination file server which has been designated by means of an address book installed on the MFP 2, or user's manual entry.

The MFP 2 generates scanned data by causing the CCD 207 to scan the document image when it receives the transmission request (S102: Yes).

Next, the MFP 2 adds to the scanned data the file information related to the scanned data including file name, data size, and thumbnail image data (S104).

Next, the MFP 2 determines the destination file server based on the information on user-specified transmission destination (S105), and transmits the authorization request to the destination file server (S106).

In step S107, the MFP2 makes a judgment as to whether or not the authorization result sent from the file sever is “OK”. If the authorization result turns out “NG” (S107: No), the MFP 2 terminates the entire process in FIG. 11 after issuing an authorization error (S109).

On the other hand, if the authorization result turns out “OK” (S107: Yes), the MFP 2 transmits the scanned data with the file information to the file server via the NIC 209 (S108).

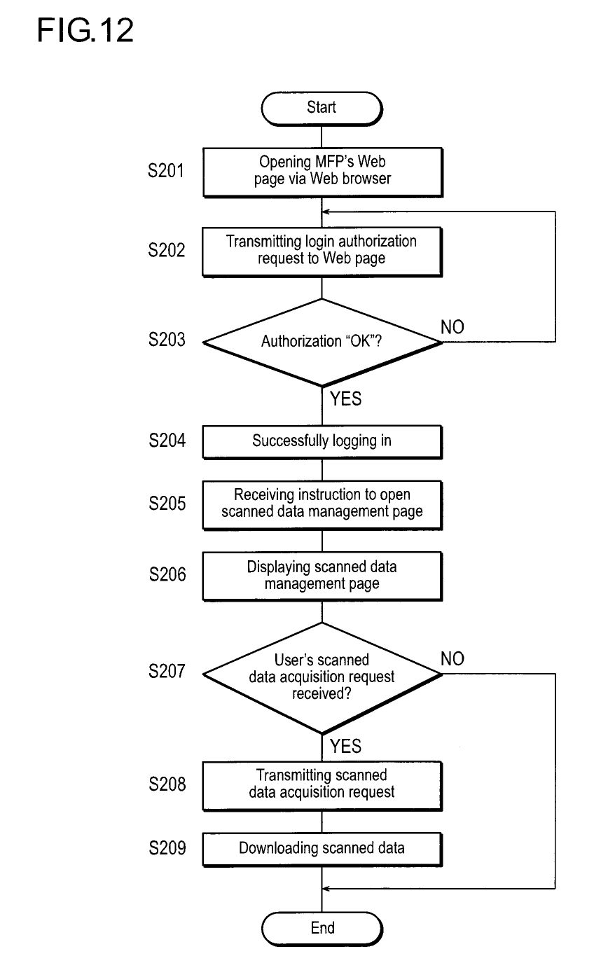

FIG. 12 is a flowchart showing the steps of the scanned data acquisition process executed by the PC 1. The algorithm shown in the flow chart of FIG. 12 is stored as a program in the memory unit to be executed by the CPU.

The PC 1 activates the Web browser in response to user's instruction, and opens the Web page offered by the MFP 2 (S201). In other words, the user can access MFP 2's Web server function unit via the Web browser in order to open the Web page when he/she intends to acquire scanned data.

The PC 1 transmits to the MFP 2 the authorization request for login to the Web page (S202) when the user make an access request on the login screen of the Web page using his/her private account or a general account.

In step S203, the PC 1 makes a judgment as to whether or not the authorization result sent from the MFP 2 is “OK”. When the authorization result turns out “NG” (S203: No), the program returns to step S202.

On the other hand, if the authorization turns out “OK” (S203: Yes), the PC 1 succeeds in logging into the Web page (S204).

Upon receiving user's instruction to open the scanned data management page (S205), the PC 1 displays the scanned data management page offered by the MFP 2 (S206).

The display form of the scanned data management page depends on user's instruction using the display switching unit 801, and can be one of the thumbnail display (refer to FIG. 9) and the list display (refer to FIG. 10), which can be switched to each other.

The server information including file server names associated with the authorized users in the server management table 700 (refer to FIG. 8) is laid out in a graphical manner on the scanned data management page, together with the file information for the scanned data stored in the directory of the file server which has been designated as a transmission destination directory. Consequently, display contents of the server information on the scanned data management page are subject to the limitations according to the account name used for the login to the Web page.

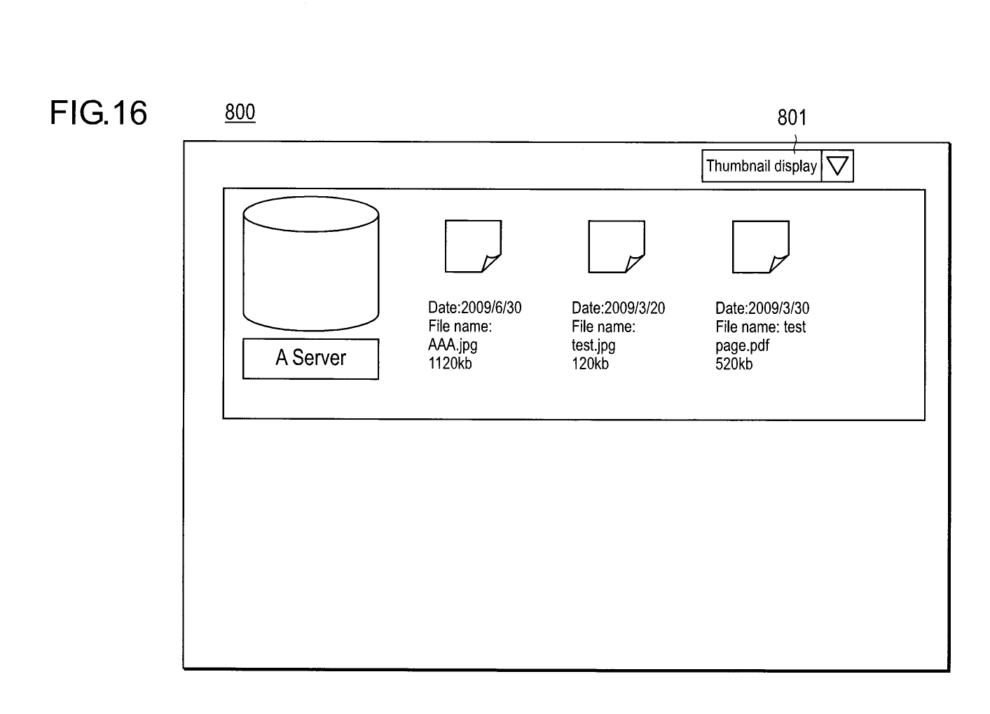

FIG. 16 is a schematic view of the scanned data management page to be displayed when the user with an account name “User B” logs in. In the present embodiment, the user with the account name “User B” is associated with the file server A (Device name “ServerA”) in the scanned data management table (refer to FIG. 8). Therefore, the sever information for the file server A is laid out on the scanned data management page 800, together with the file information for the scanned data stored in the file server A. On the other hand, the aforementioned FIG. 9 is a schematic view of the scanned data management page to be displayed when the user with account name “User A” logs in. In the present embodiment, the user with account name “User A” is associated with the file server A (Device name “Server A”) and the file server B (Device name “Server B”) in the server management table 700 (refer to FIG. 8). Therefore, the server information for the file server A and the file information for the scanned data stored in the file server A are laid out on the scanned data management page 800, in parallel with the server information for the file server B and the file information for the scanned data stored in the file sever B. Moreover, even though the access to the file server A has been authorized, the server information for the file server A is only laid out on the scanned data management page as there is no scanned data in the file server A.

As shown in FIG. 9, FIG. 10, and FIG. 16, the file information laid out on the scanned data management page is accompanied by the server information for the file server which has been the transmission source of the file information. This makes it easier for an user to identify the file server storing the scanned data represented by the displayed file information, and thereby to locate his/her desired scanned data.

In step S207, the PC 1 makes a judgment as to whether or not it has received the scanned data acquisition request from user. In other words, the PC 1 makes a judgment as to whether or not it has received user's selection of any file information among all the file information laid out on the scanned data management page.

If the scanned data acquisition request is received from the user (S207: Yes), the PC 1 transmits the scanned data acquisition request to the MFP 2 (S208). This takes place when the user clicks on any file information laid out on the scanned data management page (in the list or thumbnail image form).

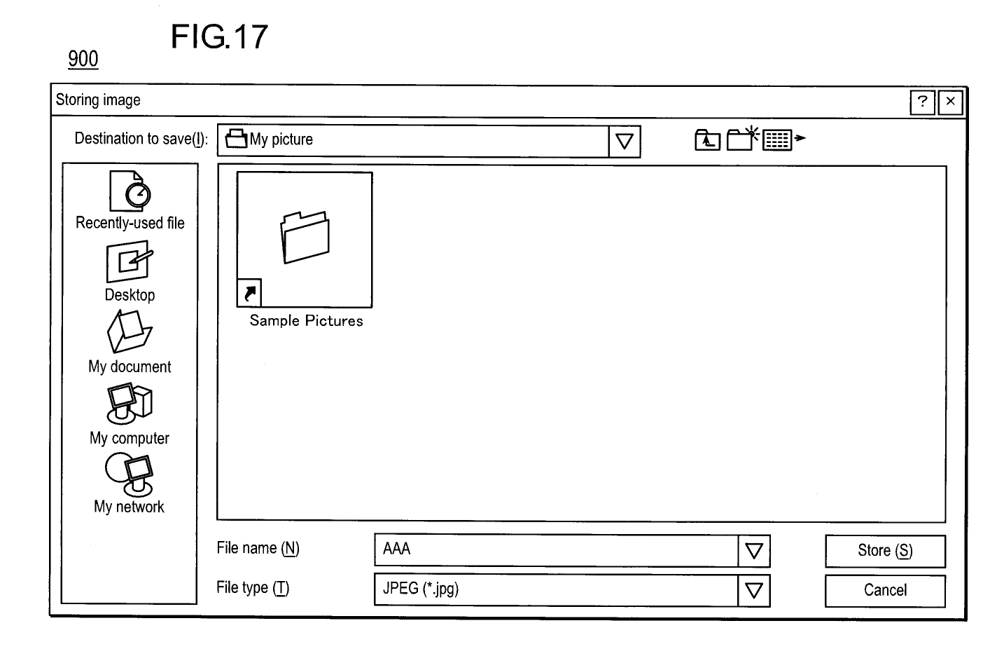

Next, the PC 1 downloads the scanned data associated with the selected file information, following user's instruction on the download execution screen like the one shown in FIG. 17 (S209).

Next, the scanned data distribution process executed by the MFP 2 will be described as follows with reference to FIG. 13 and FIG. 14:

First, the MFP 2 monitors the login authorization request to the Web page (S301), and makes a judgment as to whether or not it has received the login authorization request from the PC 1 (S302). If The MFP 2 has not received the login authorization request (S302: No), the program returns to the step S301.

If the MFP 2 has received the login authorization request (S302: Yes), the MFP 2 acquires the account name and password from the login authorization request (S303).

Next, the MFP 2 refers to the access authorization table stored in MFP 2's nonvolatile memory such as EEPROM (S304), in order to make a judgment as to whether or not the account name and password are identical to those stored in the access authorization table (S305). If the account and password are not identical to those in the access authorization table (S305: No), the MFP 2 issues an authorization error (S306), transmits the authorization result to the PC 1, and then returns to Step S301.

If the account and password are identical to those in the access authorization table (S305: Yes), the MFP 2 refers to the server management table as shown in FIG. 8 (S307), and determines the server information for the file server to be laid out on the scanned data management page (S308).

Next, the MFP 2 transmits the authorization request to the file server whose server information needs to be laid out on the Web page (i.e. the file server corresponding to the server information determined in Step S308) (S309).

Next, upon receiving the authorization result “OK” from the file server, the MFP 2 transmits to the file server which has been the transmission source of the authorization (i.e. the file server which needs to be laid out on the scanned data management page (forming a part of the Web page) based on the server management table), the acquisition request for the file information stored in the file server, in order to acquire the requested file information (S310).

The MFP 2 lays out the server information for the file server which has been the transmission source of the file information on the scanned data management page (refer to FIG. 9, FIG. 10, FIG. 16) so that the laid out server information is accompanied by the file information (S311).

Next, the MFP 2 monitors the scanned data acquisition request (S312), and makes a judgment as to whether or not it has received the scanned data acquisition request from the PC 1 (S313). If the MFP 2 has not received the scanned data acquisition request (S313: No), the program returns to the step S312.

In response to the scanned data acquisition request from the PC 1 (S313: Yes), the MFP 2 transmits the scanned data acquisition request to the file server, and acquires the requested scanned data from the file server (S314).

The MFP 2 then stores the scanned data acquired from the file server into the memory (S315), and transmits the scanned data in the memory to the PC 1 (S316).

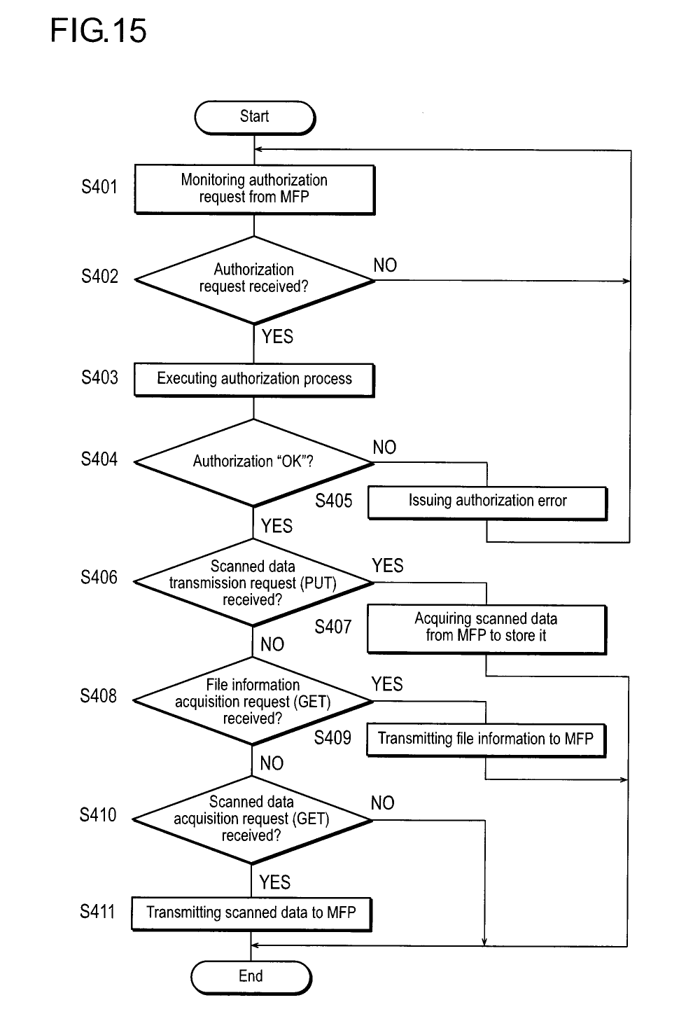

FIG. 15 is a flowchart showing the steps of the process executed by the file server. The algorithm shown in the flow chart of FIG. 15 is stored as a program in the memory unit to be executed by the CPU.

First, the file server monitors the authorization request from the MFP 2 (S401), and makes a judgment as to whether or not it has received the authorization request from the MET 2 (S402). If it has not received the authorization request (S402: No), the program returns to the step S401.

If the authorization request has been received (S402: Yes), the file server executes the authorization process based on the authorization information included in the authorization request (S403).

In Step S404, the file server makes a judgment as to whether or not the authorization result is “OK”. If the authorization result turns out “NG” (S404: No), the file server issues an authorization error (S405), transmits the authorization result to the MFP 2, and then returns to the step S401.

If the authorization result turns out “OK” (S404: Yes), the file server makes a judgment as to whether or not it has received the scanned data transmission request (PUT command) from the MFP 2 (S406). If the file server has received the scanned data transmission request (S406: Yes), it acquires from the MFP 2 the scanned data with the file information attached to itself, and stores it into the memory unit (S407).

If the file server has not received the scanned data transmission request (S406: No), it makes a judgment as to whether or not it has received the file information acquisition request (GET command) from the MFP 2 (S408). If the file server has received the file information acquisition request (S408: Yes), it extracts the file information from its own file server, and transmits it to the MFP 2 (S409).

If the file server has not received the file information acquisition request (S408: No), it makes a judgment as to whether or not it has received the scanned data acquisition request (GET command) (S410). If the file server has not received the scanned data acquisition request (S410: No), it terminates the entire process in FIG. 15.

If the file server has received the scanned data acquisition request (S410: Yes), it extracts the relevant scanned data from its own file server, and transmits it to the MFP 2 (S411).

As can be seen from the above, the MFP 2 in the present embodiment acquires from the file server which the server management table 700 (refer to FIG. 8) associates with the authorized user, the file information for the scanned data stored in the associated file server, lays it out on the Web page, and accepts the acquisition request for the scanned data corresponding to the user-selected file information among all the file information laid out on the Web page. The MFP 2 then acquires the scanned data corresponding to the user-selected file information from the file server, and distributes it to the user.

Therefore, according to the present embodiment, the Web page offered by the MFP 2 can serve as an interface for accessing the scanned data stored in the file server. This consequently removes users' need for knowing various information like IP addresses of the file servers, thereby reducing the time for searching the file servers for his/her desired scanned data.

The present embodiment can also reduce administrators' burden in configuring access authorization settings on the side of the file servers as it allows them to control access to the scanned data on the side of the MFP 2.

In other words, according to the present embodiment, users are enabled not only to find out their desired scanned data with ease, but also to control access to the scanned data with facility.

The invention is not limited to the embodiment described above, and it can be modified in various ways within the scope of the appended claims.

For example, the server management table can retain association between users and directories of the file servers while the present embodiment states that it retains association between users and file servers. Each of the file severs preferably includes a plurality of directories for storing the scanned data. In this case, the server management table will retain association between each user and more than one directory for storing the scanned data. Further, the scanned data management page will only lays out the file information for the scanned data stored in the directories which the server management table associates with the authorized user, among the file information for all the scanned data stored in the file server. Therefore, the user can only view the file information for the scanned data stored in the directories which the server management table associates with himself/herself, but he/she can not view the file information for the scanned data stored in the other directories of the same file server. This will allow for more precise access control to the scanned data per user.

The image scanning device according to the present invention can be any other device capable of scanning images although the embodiment described above uses the MFP 2. The image scanning device according to the present invention can be a scanner capable of scanning images.

Although the MFP 2 in the above embodiment is constituted in such a way as to transmit the scan data generated by scanning the document image to the file server to have it stored there, The image scanning device according to the present invention can also store part of its generated scanned data although the MFP 2 in the embodiment described above only transmits the scanned data to the file server.

The Web pages according to the present invention can also appear on MFP 2's operation panel 206 so that user's selection of the file information can be accepted on the operation panel 206 although the Web page in the embodiment described above is offered by the MFP 2 to appear on PC 1's display.

The methods and means of MFP 2's various processing in the embodiment described above can be implemented by means of a dedicated hardware circuit, or a program executed by a computer. Such a program can take a form of either a computer readable recording medium like a flexible disk and a CD-ROM, or a downloadable file supplied on-line via a network like the Internet. In the former case, the program recorded in the computer readable recording medium is normally transmitted to a memory unit like a hard disk. The program can also take a form of an independent application software, or a built-in function of the image scanning device.

What is claimed is:

1. An image scanning device capable of communicating with file storage devices, comprising:
an image scanning unit for scanning a document image to generate scanned data;
a scanned data transmission unit for transmitting the generated scanned data to have a file storage device to store it;
a Web server function unit for offering a Web page;
a memory unit for storing a server management table for managing association between users and file storage devices;
an authorization unit for authorizing an user accessing said Web server function unit;
a file information acquisition unit for acquiring from the file storage device which said server management table associates with the user having been authorized by said authorization unit, the file information for the scanned data stored in the associated file storage device;
a layout unit for laying out the acquired file information on said Web page;
a reception unit for receiving an acquisition request for the scanned data corresponding to the user-selected file information among all the file information laid out on said Web page;
a scanned data acquisition unit for acquiring the scanned data corresponding to the user-selected file information, from the file storage device which has been the transmission source of the user-selected file information; and
a scanned data distribution unit for distributing the acquired scanned data to the user.

2. The image scanning device as claimed in claim 1, wherein
said layout unit lays out server information for the file storage device which said server management table associates with the authorized user on said Web page, so that said file information on said Web page is accompanied by the server information for the file storage device which has been the transmission source of said file information on said Web page.

3. The image scanning device as claimed in claim 1, wherein
each of said file storage devices has a plurality of directories, said server management table manages association between users and at least one of said directories, and said Web page lays out the file information for the scanned data in the directories which said server management table associates with the authorized user among all the scanned data stored in the file storage device.

4. The image scanning device as claimed in claim 1, wherein
said file information includes thumbnail image data representing the scanned data.

5. The image scanning device as claimed in claim 1, wherein
said file information takes a form of either a list of information on the scanned data including file names, or thumbnail images representing the scanned data, and said list and said thumbnail images can be switched to each other according to user's instruction.

6. A computer readable recording medium storing a program causing an image scanning device capable of communicating with file storage devices to execute the steps of:
(a) scanning a document image to generate scanned data;
(b) transmitting the generated scanned data to have a file storage device to store it;
(c) authorizing an user accessing a Web server function unit designed to offer a Web page;
(d) referring to a server management table stored in a memory unit for managing association between users and file storage devices;
(e) acquiring from the file storage device which said server management table associates with the user having been authorized in said step (c), the file information for the scanned data stored in the associated file storage device;
(f) laying out the acquired file information on said Web page;
(g) receiving an acquisition request for the scanned data corresponding to the user-selected file information among all the file information laid out on said Web page;
(h) acquiring the scanned data corresponding to the user-selected file information, from the file storage device which has been the transmission source of the user-selected file information; and
(i) distributing the acquired scanned data to the user.

7. The recording medium as claimed in claim 6, wherein
in said step (f), said Web page lays out the server information for the file storage device which said server management table associates with the authorized user, so that said file information on said Web page is accompanied by the server information for the file storage device which has been the transmission source of said file information.

8. The recording medium as claimed in claim 6, wherein
each of said file storage devices has a plurality of directories, said server management table manages association between users and at least one of said directories, and said Web page lays out the file information for the scanned data in the directories which the server control table associates with the authorized user among all the scanned data stored in the file storage device.

9. The recording medium as claimed in claim 6, wherein
said file information includes thumbnail image data representing the scanned data.

10. The recording medium as claimed in claim 6, wherein
said file information takes a form of either a list of information on the scanned data including file names, or thumbnail images representing scanned data, and said list and said thumbnail images can be switched to each other according to user's instruction.
